(19) United States
(12) Patent Application Publication
(10) Pub. No.: US 2020/0052631 A1
(43) Pub. Date: Feb. 13, 2020

(54) ELECTRIC SYSTEM ARCHITECTURE WITH A PERMANENT MAGNET GENERATOR AND INTERLEAVED ACTIVE RECTIFIERS

(71) Applicant: Hamilton Sundstrand Corporation, Charlotte, NC (US)

(72) Inventors: Gregory I. Rozman, Myrtle Beach, SC (US); Steven J. Moss, Rockford, IL (US)

(21) Appl. No.: 16/101,607

(22) Filed: Aug. 13, 2018

(51) Int. Cl. H02P 9/48; H02P 9/30; H02P 21/18

(52) U.S. Cl. CPC H02P 9/48; H02P 21/18; H02P 9/307

(57) ABSTRACT

According to one or more embodiments, a method and system for electric power generation are provided. The embodiments include a permanent magnet generator (PMG), a rectification stage operably coupled to the PMG, a position sensor coupled to the PMG, and a controller operably coupled to the rectification stage. The controller includes a voltage regulator configured to receive a voltage reference and an output voltage of the system, and a current regulator in communication with the voltage regulator. The controller also includes a selective harmonic compensator comprising a current harmonic selector, wherein the selective harmonic compensator is configured to produce a compensation signal for a selected harmonic.

### BACKGROUND

The subject matter disclosed herein relates generally to the field of power generating systems, and more particularly to electric generating system architectures with 6-phase PMG and interleaved active rectifiers.

Generally, power generating systems for aircraft and other vehicles employ a permanent magnet generator (PMG), active rectifier and a controller. The design of the PMG must account for losses caused by the harmonic distortion present in the power signal. There may be a need to improve the performance of the electric power system by filtering and canceling unwanted torque and current ripple and generate a high-quality DC output power.

### BRIEF DESCRIPTION

According to an embodiment, a system for electric power generation is provided. The system includes a permanent magnet generator (PMG), a rectification stage operably coupled to the PMG, a position sensor coupled to the PMG, and a controller operably coupled to the rectification stage. The controller includes a voltage regulator configured to receive a voltage reference and an output voltage of the system, and a current regulator in communication with the voltage regulator. The controller also includes a selective harmonic compensator comprising a current harmonic selector, wherein the selective harmonic compensator is configured to produce a compensation signal for a selected harmonic.

In addition to one or more of the features described herein, or as an alternative, further embodiments include an output of the rectification stage that is coupled to a filtering stage.

In addition to one or more of the features described herein, or as an alternative, further embodiments include a 6-phase PMG having a first set of windings and a second set of windings, wherein an output of the second set of windings is phase shifted 30° from an output of the first set of windings.

In addition to one or more of the features described herein, or as an alternative, further embodiments include a rectification stage having a first active rectifier and a second active rectifier, wherein the second active rectifier is phase shifted 180° from the first active rectifier to reduce voltage ripple on a DC bus.

In addition to one or more of the features described herein, or as an alternative, further embodiments include a first active rectifier and a second active rectifier that are configured to operate in an interleaved manner.

In addition to one or more of the features described herein, or as an alternative, further embodiments include a PWM that is configured to control the rectification stage based on alpha-beta components of a voltage reference signal and compensation signals.

In addition to one or more of the features described herein, or as an alternative, further embodiments include a PWM that configured to control the rectification stage based on voltage reference signals from a dq-to-abc transformation.

8 In addition to one or more of the features described herein, or as an alternative, further embodiments include a PWM that is configured to control the rectification stage based on proportional integrals of current errors of the rectification stage.

In addition to one or more of the features described herein, or as an alternative, further embodiments include a voltage regulator that is configured to provide d-q components of a reference current to the current regulator

In addition to one or more of the features described herein, or as an alternative, further embodiments include a “d” component of the d-q components of the current reference (Id) that is set to 0.

In addition to one or more of the features described herein, or as an alternative, further embodiments include a “q” component of the d-q components of the current reference that is based at least in part on a power reference, PMG speed, and torque reference.

In addition to one or more of the features described herein, or as an alternative, further embodiments include a selective harmonic compensator that is configured to select a harmonic component to cancel from the output of the system.

In addition to one or more of the features described herein, or as an alternative, further embodiments include a selective harmonic compensator having a plurality of current harmonic selectors that is configured to cancel a plurality of harmonics from the DC bus.

In addition to one or more of the features described herein, or as an alternative, further embodiments include a selective harmonic compensator having a summer that is configured to sum each component of a compensation signal from the plurality of current harmonic selectors.

According to another embodiment, a method is provided that includes generating output power using a permanent magnet generator (PMG), determining an error by a voltage sensor and a current sensor coupled to the PMG, and selecting a harmonic to cancel from the output power based at least in part on the error. The method also includes generating a compensation signal based on the harmonic, and canceling the harmonic from the output power.

In addition to one or more of the features described herein, or as an alternative, further embodiments include controlling a pulse width modulation scheme of a rectification stage based an output of a dq-to-abc transformation.

In addition to one or more of the features described herein, or as an alternative, further embodiments include controlling a pulse width modulation scheme of a rectification stage based an output of a dq-to-αβ transformation.

In addition to one or more of the features described herein, or as an alternative, further embodiments include combining the output of the dq-to-αβ transformation with a compensation signal generated for a selected harmonic.

### BRIEF DESCRIPTION OF THE DRAWINGS

The following descriptions should not be considered limiting in any way. With reference to the accompanying drawings, like elements are numbered alike:

FIG. 1 is a DC power generating system architecture with a 6-phase PMG and interleaved active rectifiers in accordance with one or more embodiments;

FIG. 2 depicts controllers for the DC power generating system in accordance with one or more embodiments;

FIG. 3 depicts a control diagram for an active rectifier controller in accordance with one or more embodiments;

FIG. 4 depicts a control diagram for active rectifier controllers with selective harmonics compensation;

FIG. 5 depicts a phase current harmonics compensator in accordance with one or more embodiments; and

FIG. 6 depicts a phase current selected harmonic selector in accordance with one or more embodiments.

### DETAILED DESCRIPTION

The design of a 6-phase PMG eliminates sixth harmonic torque pulsation caused by harmonic components in the stator current. However, certain current harmonics can be easily increased in 6-phase PMG because of the low impedance current path resulting in additional losses. There is a need for a power generating system that optimally integrates a 6-phase PMG and power converter into a high power density alternator with optimum power quality, reduced losses, and low torque pulsation.

Direct current (DC) power generating system architectures include 6-phase variable-speed PMG that are coupled to two-level active rectifiers. The 6-phase PMG includes two sets of winding in asymmetric configurations that feature a 30° phase shift between two sets of three-phase windings. The currents of the order 6n±1 do not contribute to either the average torque or torque ripple production. These harmonics do not produce air-gap flux and are only limited by the stator resistance and leakage inductance of the PMG which can be easily excited by the voltage source (active rectifier), causing additional losses. The techniques described herein provide for a current harmonic compensator that selects and cancels harmonics that contribute to the PMG losses and torque pulsation.

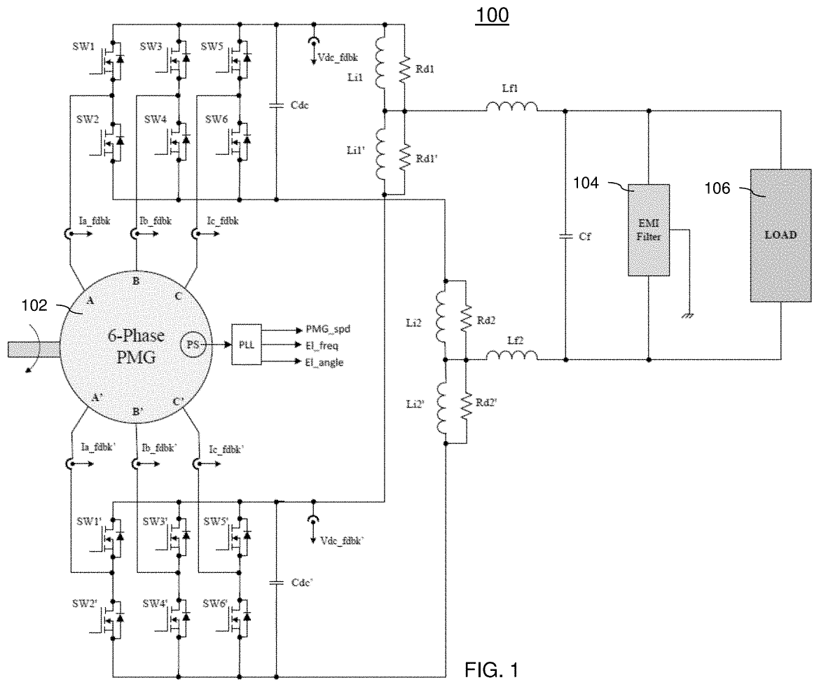

Now turning to FIG. 1, a DC power system 100 is shown. The DC power system 100 includes a 6-phase permanent magnet generator (PMG) is shown. The PMG 102 includes two sets of 3-phase windings (not shown). The output of the first set of windings provides a 3-phase output A, B, C. The output of the second set of windings provides a 3-phase output A′, B′, and C′. In one or more embodiments, the first set of winding is phase shifted 30° from the second set of winding to reduce the ripple at the output of the DC bus of the system 100. The PMG 102 also includes a position sensor (PS), such as a Hall effect position sensor, that is in communication with a phase-locked loop (PLL) that is configured to determine the rotational speed, electrical frequency, and electrical angle of the PMG 102.

The system 100 includes voltage and current sensors in communication with each phase output of the PMG at point Vdc_fdbk measured across the capacitor Cdc and at points Ia_fdbk, Ib_fdbk, and Ic_fdbk at the output of the PMG 102. The voltage and current sensors are configured to provide voltage feedback signals for each phase output of the PMG 102. Similarly, voltage and current sensors are in communication with the second rectifier to measure Vdc_fdbk′ and Ia_fdbk′, Ib_fdbk′, and Ic_fdbk′

The system 100 includes an active rectifier 104A that includes a plurality of switches SW1, SW2, SW3, SW4, SW5, and SW6, and is configured to switch on/off in response to pulse width modulated (PWM) signal applied from a gate drive (not shown). The active rectifier 104A further includes a DC capacitor Cdc that is coupled across the output of each switch of the plurality of switches. The active rectifier 104A further includes interface inductors Li1 and Li2, The resistors Rd1 and Rd2 may be arranged on the DC output bus, in parallel communication with inductances Li1 and Li2, respectively.

The system 100 also includes a second active rectifier 104B having a plurality of switches SW1′, SW2′, SW3′, SW4′, SW5′, and SW6′. The active rectifier 104A further includes a DC capacitor Cdc′ that is coupled across the output of each switch of the plurality of switches. The active rectifier 104B further includes interface inductors Li1′ and Li2′. The resistors Rd1′ and Rd2′ may be arranged on the DC output bus, in parallel communication with inductances Li1′ and Li2′, respectively. The interface inductors and damper helps reduce oscillations provided by any capacitor connection at the output of the DC bus. In one or more embodiments, the first and second rectifiers are referred to as a rectification stage of the system 100. Furthermore, a filter capacitor Cf and electromagnetic interference (EMI) filter 104, may be arranged across the DC output bus. Since the architecture shown in FIG. 1 operates the rectifier and the second rectifier in an interleaved manner, the first and second 3-phase outputs produce less torque ripple and current ripple on the output of the DC bus. Therefore, smaller components can be used and a higher quality signal can be provided.

The system 100 further includes a load 106 in communication with the first and second active rectifiers. The load may be any suitable DC load applied to the DC output bus of the active rectifiers. For example, as described above, the DC load may be a relatedly large and constant DC load.

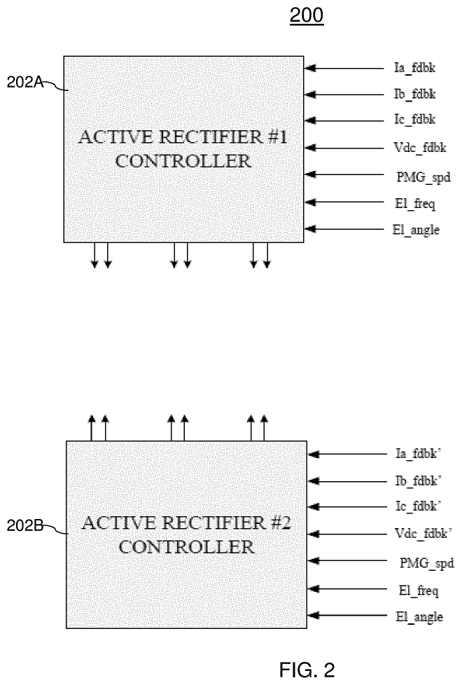

In FIG. 2, the first and second active rectifier controllers 202A and 202B in accordance with one or more embodiments are shown. The active rectifier controller 202A is configured to control the rectifier shown in FIG. 1. The active rectifier controller 202A controls the opening and closing of the switches SW1-SW6 based on current and voltage feedback signals including Ia_fdbk, Ib_fdbk, Ic_fdbk, and Vdc_fdbk. In addition, the active rectifier controller 202B is shown and is further configured to control the active rectifier. The active rectifier controller 202B controls the opening and closing of the switches SW1′-SW6′ based on feedback signals including (Ia_fdbk′, Ib_fdbk′, Ic_fdbk′, and Vdc_fdbk′). The active rectifier controllers 202A and 202B are configured to receive the rotational speed (PMG_spd), the electrical frequency (El_freq), and the electrical angle (El_angle) of the PMG 102 which is in communication with the PLL coupled to the position sensor shown in FIG. 1.

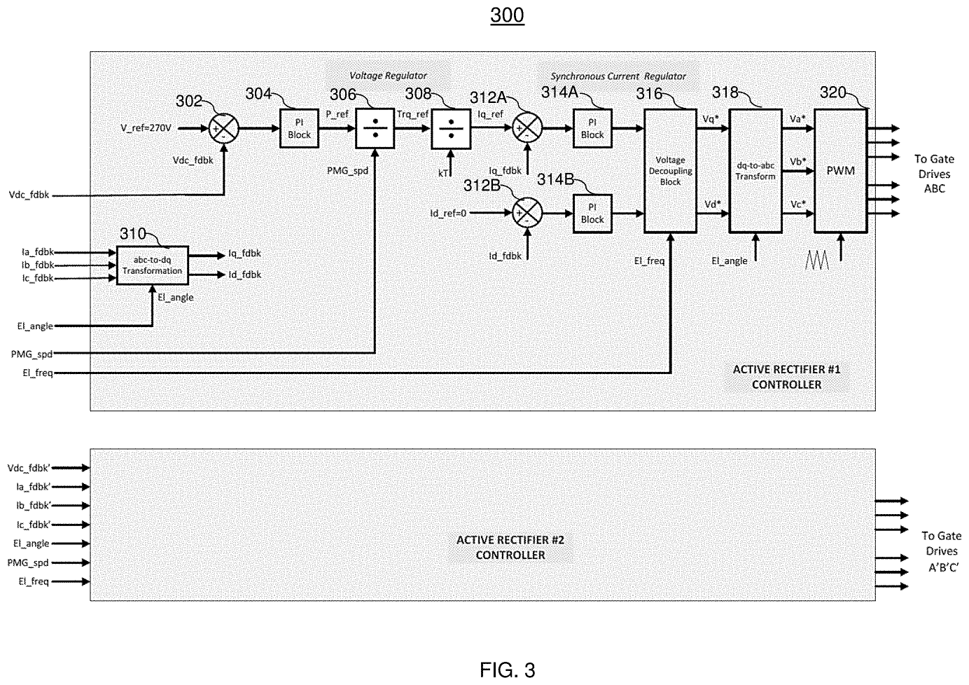

Now referring to FIG. 3, a control circuit 300 for the active rectifier controllers 202A, 202B in accordance with one or more embodiments is shown. As illustrated, the voltage regulator receives a reference voltage and feedback voltage from an active rectifier (e.g., first active rectifier of FIG. 1). The difference between the reference and feedback voltages is determined at summer 302. The difference is provided to PI block 304 to derive an active power reference (P_ref). At division block 306, the power reference P_ref signal and the PMG speed (PMG_spd) is received and converted into a torque reference (Trq_ref). Next, at division block 308, the torque reference Trq_ref is divided by the torque constant (kT) to derive a quadrature component (Iq_ref) of the PMG stator current.

The active rectifier controller 300 also includes an abc-to-dq transformation block 310 to convert the current feedback Ia_fdbk, Ib_fdbk, Ic_fdbk for the three phases to two-phase current feedback (Iq_fdbk, Id_fdbk). A summer 312A is configured to receive the current reference Iq_ref and Iq_fdbk and provide the difference to the PI block 314A. At the summer 312B, the current reference Id_ref is set to 0 and is compared to Id_fdbk where the error is provided to PI block 314B. The direct component Id_ref of the stator current is set to zero to obtain maximum torque per amp.

The output of the PI block 314A and 314B can be provided to a voltage decoupling block 316, where the d-q components of the voltage vector are decoupled at voltage decoupling block 316. The voltage decoupling block 316 improves the stability of the current loops and may be optional. The voltage decoupling block 316 receives the electrical frequency (EI_freq) to produce the components Vq* and Vd*.

The dq-to-abc transform block 318 is configured to receive the quadrature voltage reference Vq* and the direct voltage reference Vd* and the electric angle to convert the components into the voltage reference signals Va*, Vb*, and Vc*. The PWM 320 is configured to receive the voltage reference signals Va*, Vb*, and Vc* and a reference signal such as a triangle wave. The resulting PWM signals are provided to the gate drives (not shown) to control the switching of the rectifier 104A. The carrier signal of each of the current regulator PWM is phase shifted by 180° (interleaving). The outputs of the current regulators PWM are connected to the switch gates via gate drive (not shown). The system 100 includes the gate drives in communication with the active rectifiers shown in FIG. 1. The gate drive may be configured to open and close each of the plurality of switches S1-S6. A second active rectifier controller having the same architecture as the first active rectifier controller is shown in FIG. 3 and is configured to control the second rectifier shown in FIG. 1

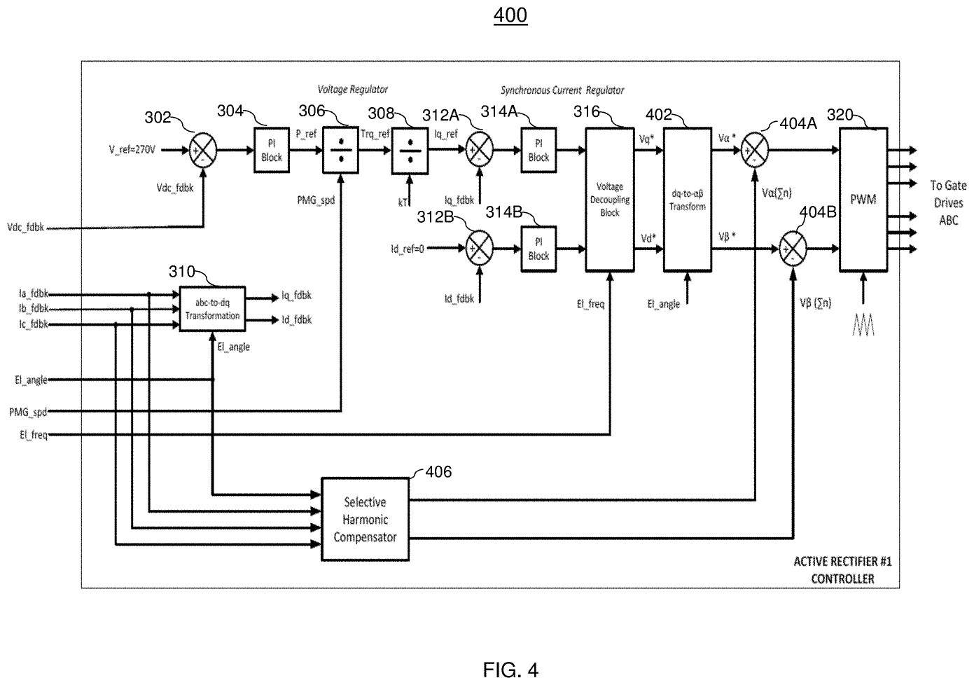

Now referring to FIG. 4, the active rectifier controller 400 includes a similar architecture as that shown in FIG. 3. The active rectifier controller 400 further includes a dq-to-αβ transform block 402 coupled to summers 404A and 404B. The summers 404A and 404B are also configured to receive the compensation signals from the selective harmonic compensator 406 to remove the selected harmonics which is described in further detail below.

The active rectifier controller 400 includes a selective harmonic compensator 406 which is configured to receive the current feedback from each phase Ia_fdbk, Ib_fdbk, Ic_fdbk and the electric angle information from the PLL from the PMG shown in FIG. 1. The output of the selective harmonic compensator 406 is provided to the summers 404A and 404B to eliminate and/or significantly reduce the selected stator current harmonics in a closed loop arrangement. The summers 404A and 404B are located between the dq-to-αβ transform 402 and the PWM 320. The PWM uses the compensated signals to control gate drives that switch the switches of the rectifier. It is to be understood that a second active rectifier operating on the 6-phase PMG having a similar architecture as the active rectifier 400 is used.

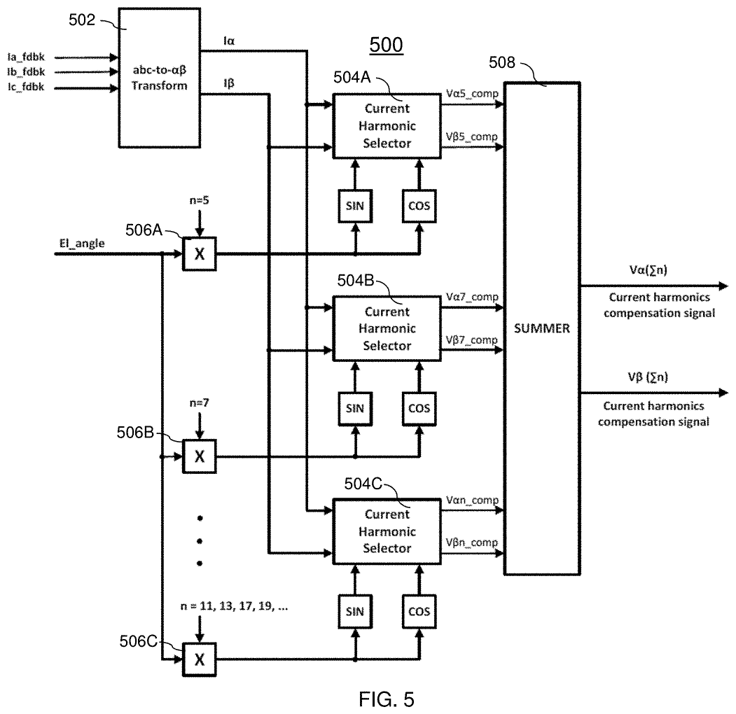

In FIG. 5, a diagram of a phase current harmonics compensator 500 is shown. In one or more embodiments, the phase current harmonics compensator 500 (hereinafter referred as compensator 500) is the compensator 406 shown in FIG. 4. The compensator 500 includes an abc-to-ββ transform block 502 that is configured to receive the current feedback Ia_fdbk, Ib_fdbk, Ic_fdbk for each phase of the PMG and converts 3-phase stator currents to stationary quadrature signals Iα and Iβ.

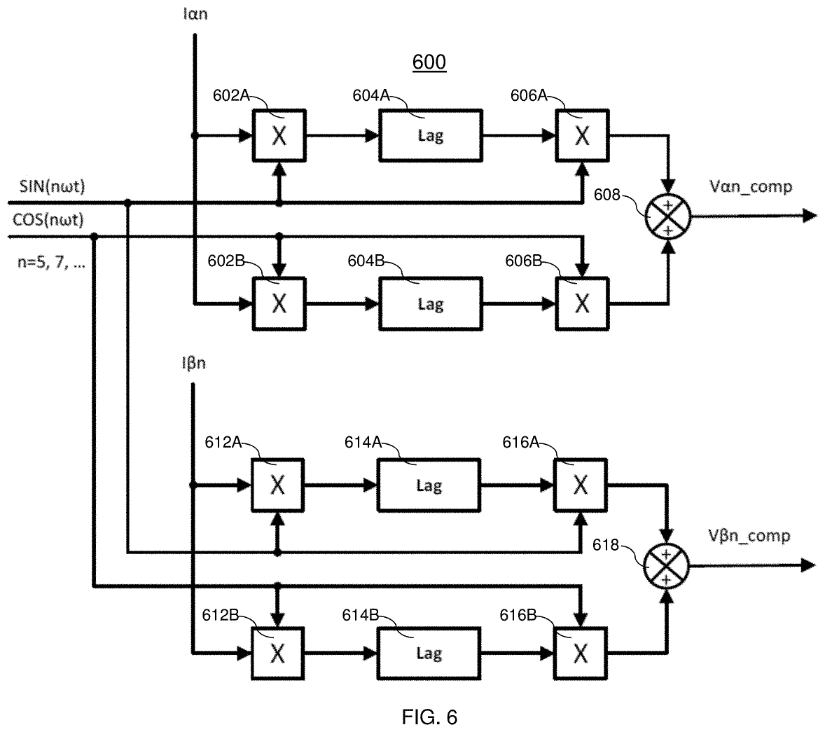

The current feedback to and produces the vector components Iα and Iβ. The compensator 500 includes a plurality of current harmonic selectors 504A, 504B, and 504C where each of the current harmonic selectors 504 is configured to receive the vector components Iα and Iβ. The compensator 500 also includes a plurality of multipliers 506A, 506B, and 506C for each harmonic to be compensated and/or reduced. For example, the n^{th} harmonic is of the first selector 504A n=5. In one or more embodiments, n=5, 7, 11, 13, 17, 19 . . . . The multiplier 506A receives the electrical angle (EI_angle) and provides a sin and cos component to each current harmonic selector 502A. The output of the current harmonic selector 504A provides a compensation signal Vβ5_comp and Vβ5_comp to the summer 508 to produce a current harmonic compensation signal Vαn(Σn) and Vβn(Σn). Further details of the current harmonic selector 504 are described with reference to FIG. 6.

In FIG. 6, a diagram of a phase current selected harmonic selector 600 is shown. The phase current selected harmonic selector 600 (hereinafter referred to as harmonic selector 600) processes the direct and quadrature vector components of the input vector (Iαn and Iβn) in respective channels to produce time-varying compensation signal (Vαn_comp and Vβn_comp) that are used to filter out the unwanted harmonic signals.

A first channel includes first multipliers 602A, 602B, lag circuit 604A, 604B, second multipliers 606A, 606B, and summer 608. A second channel includes first multipliers 612A, 612B, lag circuit 614A, 614B, second multipliers 616A, 616B, and summer 618. The first multipliers 602A, 602B of the first channel multiplies the quadrature sinusoidal signal (sin and cos) of a selected harmonic with the quadrature vector components of the input vector Iαn and Iβn which includes all of the harmonics of the input signal.

The lag circuit 604A, 604B of the first channel filters/eliminates the higher frequency components/harmonics from the input vector. Although a lag circuit 604A, 604B is shown, it should be understood that a PI block can also be used in other embodiments. The output of the lag circuit 604A, 604B is provided to the second set of multipliers 606A, 606B. The second multipliers 606A, 606B of the first channel multiply the output of the lag circuit 604a, 604B with the input of the quadrature sinusoidal signals sin(nωt) and cos(nωt). The output of the second set of multipliers 606A, 606B is summed at the summer 208 to produce the compensation signal Vαn_comp for the first channel and is used to cancel the unwanted harmonics at block 404A of FIG. 4.

In a similar fashion, the first set of multipliers 612A, and 612B of the second channel receives the Iβn which includes all of the harmonics of the input signal. The lag circuit 614A, 614B removes the higher frequency harmonics from the signal and provides the filtered signal to the second set of multipliers 616A, 616B. The multipliers 616A, 616B multiplies the signal with the input of the quadrature sinusoidal signals sin(nωt) and cos(nωt). The output of the second set of multipliers 616A, 616B is summed at the summer 208 to produce the compensation signal Vβn_comp for the second channel and is used to cancel the unwanted harmonics at block 404A of FIG. 4. As shown in FIG. 5, each component for each channel is summed at the summer 608 to produce a current harmonics compensation signal.

The technical effects and benefits include the cancelation of harmonics that contribute to PMG losses and torque pulsation using the stator current compensator. The technical effects and benefits also include the reduction in PMG phase current rating resulting in increased efficiency due to the reduction of stator copper losses, and a reduction in PMG torque pulsation due to canceling sixth harmonics. The technical effects and benefits include improvements in power quality by reducing output voltage ripple without an increase of output power quality filter size due to lower dc link current harmonic content and reduced active rectifier semiconductors current ratings. The technical effects and benefits also provide for improved efficiency by reducing conduction losses of semiconductor devices due to the reduced current through each phase. The technical benefits also include improved power density and provide a modular approach using standard power modules.

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A system for electric power generation, the system comprising:
a permanent magnet generator (PMG);
a rectification stage operably coupled to the PMG;
a position sensor coupled to the PMG;
a controller operably coupled to the rectification stage, wherein the controller further comprises:
a voltage regulator configured to receive a voltage reference and an output voltage of the system;
a current regulator in communication with the voltage regulator;
a selective harmonic compensator comprising a current harmonic selector, wherein the selective harmonic compensator is configured to produce a compensation signal for a selected harmonic, wherein the compensation signal includes a first alpha component and a second beta component that are provided to a first summer and a second summer, respectively, at the input of the PWM.

2. The system of claim 1, wherein an output of the rectification stage is coupled to a filtering stage.

3. The system of claim 1, wherein the PMG is a 6-phase PMG comprising a first set of windings and a second set of windings, wherein an output of the second set of windings is phase shifted 30° from an output of the first set of windings.

4. The system of claim 1, wherein the rectification stage comprises a first active rectifier and a second active rectifier, wherein the second active rectifier is phase shifted 180° from the first active rectifier to reduce voltage ripple on a DC bus.

5. The system of claim 4, where the first active rectifier and the second active rectifier are configured to operate in an interleaved manner.

6. The system of claim 1, further comprises a pulse width modulation (PWM) signal configured to control the rectification stage based on alpha-beta components of the voltage reference signal and compensation signals.

7. The system of claim 1, further comprises a PWM signal configured to control the rectification stage based on voltage reference signals from a direct quadrature to three phase (dq-to-abc) transformation.

8. The system of claim 7, wherein the PWM signal is configured to control the rectification stage based on proportional integrals of current errors of the rectification stage.

9. The system of claim 1, wherein the voltage regulator is configured to provide direct-quadrature (d-q) components of a reference current to the current regulator

10. The system of claim 9, wherein a d component of the d-q components of the current reference is set to 0.

11. The system of claim 9, wherein a q component of the d-q components of the current reference is based at least in part on a power reference, PMG speed, and torque reference.

12. The system of claim 1, wherein the selective harmonic compensator is configured to select a harmonic component to cancel from the output of the system.

13. The system of claim 12, wherein the selective harmonic compensator comprises a plurality of current harmonic selectors configured to cancel a plurality of harmonics from the DC bus.

14. The system of claim 12, wherein the selective harmonic compensator comprises a summer configured to sum each component of the compensation signal from the plurality of current harmonic selectors.

15. A method comprising:
generating output power using a permanent magnet generator (PMG);
determining an error by a voltage sensor and a current sensor coupled to the PMG;
selecting a harmonic to cancel from the output power;
generating a compensation signal based on the harmonic, wherein the compensation signal includes a first alpha component and a second beta component that are provided to a first summer and a second summer, respectively, at the input of a PWM module; and
canceling the harmonic from the output power.

16. The method of claim 15, further comprising controlling a pulse width modulation scheme of a rectification stage based an output of a dq-to-abc transformation.

17. The method of claim 15, further comprising controlling a pulse width modulation scheme of a rectification stage based an output of a dq-to-αβ transformation.

18. The method of claim 17, further comprising combining the output of the dq-to-αβ transformation with the compensation signal generated for the selected harmonic.
